(19) United States
(12) Patent Application Publication
(10) Pub. No.: US 2025/0336976 A1
(43) Pub. Date: Oct. 30, 2025

(54) ELECTRODE WITH GRADED ALLOY LAYER, BATTERY AND METHOD

(71) Applicant: LionVolt B.V., Eindhoven (NL)

(72) Inventors: Freddy ROOZEBOOM, Waalre (NL); Sandeep UNNIKRISHNAN, Veldhoven (NL); Sathiyaraj KANDHASAMY, Eindhoven (NL); Bihag ANOTHUMAKKOOL, Eindhoven (NL)

(21) Appl. No.: 18/866,479

(22) PCT Filed: May 15, 2023
(86) PCT No.: PCT/NL2023/050272

§ 371 Date: Nov. 15, 2024

(30) Foreign Application Priority Data
May 16, 2022 (NL) 2031863

(51) Int. Cl. H01M 4/62; H01M 4/04; H01M 4/36; H01M 10/052; H01M 12/08

(52) U.S. Cl. CPC H01M 4/628; H01M 4/0404; H01M 4/0423; H01M 4/045; H01M 4/366; H01M 10/052; H01M 12/08

(57) ABSTRACT

The present disclosure relates to an electrode (1) for a secondary lithium metal battery, the electrode comprises: a current collector (2), an anode metal layer (3) comprising lithium, and at least one graded metal alloy layer (4a,4b) that extends along one or more opposing faces of the anode metal layer. The graded metal alloy layer comprising a mixture of lithium and a further metal composition, whereby the concentration of lithium relative to the further metal composition decreases outwardly from the anode metal layer. The disclosure further relates to a battery comprising the electrode and a method of manufacturing.

### TECHNICAL FIELD AND BACKGROUND

The present disclosure relates to an electrode for a secondary battery, in particular a secondary lithium metal battery, a method of manufacturing, and to batteries comprising the electrode.

Rechargeable lithium-ion batteries (LiBs) are today's technology of choice in electromobility and renewable energy storage grids. To improve energy density, next-generation battery technologies tend to move towards lithium metal anodes, with a potentially high specific capacity of 3860 mAh/g and a low redox potential of −3.04 V. These anodes may be combined with a cathode from various chemistry choices such as NMC (lithium nickel manganese cobalt oxide), LFP (lithium iron phosphate), LNMO (lithium nickel manganese oxide), sulfur, or air.

During charging Li-ions travel from the cathode through an electrolyte to the anode to be deposited as Li metal (Li⁰). During discharge they travel back to the cathode. However, during plating/stripping cycles the battery incurs losses of lithium due to adverse reactions of lithium with the electrolyte and/or due to generation of porous or dendritic lithium deposits, which further present a progressively increasing danger in shorting, reducing operable battery lifetime and performance.

J. Lou, et al., (Nanomaterials 11, 300, 2021) describes a LiSn alloy anode composition to inhibit lithium dendrite growth. However, the layer comprises only a single overall composition made up by a comparatively large amount of non- or not optimally Li-conducting material, which may be regarded as dead weight in terms of electrical efficiency, which does not partake in battery reaction. Also the chemo-mechanical stability leaves room for improvement both in terms of the mechanical expansion coefficient and the electric field lines across the interlayer.

C. Zhong, et al., (Materials Today Energy 18, 100528, 2020) describes various multi-element Sn—Co—Sb alloy anodes for holding Li with different ratios of Sn:Co:Sb. The alloy compositions are manufactured by tilting the substrates. Thus the alloy compositions are not homogeneous over any horizontal subplane parallel to the substrate. Consequently, in a vertical direction the composition at every localized spot is different and made up by a comparatively large amount of non-or not optimally Li-conducting material (dead weight in terms of electrical efficiency) that does not partake in battery reaction.

### SUMMARY

The present disclosure aims to negate or at least mitigate one or more of the above disadvantages by providing an electrode, method and battery as disclosed herein.

The present invention further aims to provide a battery having improved performance and/or lifetime by mitigating one or more of: adverse reactions of anode metal during manufacturing and/or adverse volume and surface changes upon repeated insertion and extraction of Li upon battery cycling, especially in an initial charging cycle. As explained in more detail herein below the electrode as disclosed herein can advantageously contribute towards one or more of the above aims.

According to a first aspect an electrode is provided, in particular an electrode for a secondary lithium metal battery. The electrode comprises at least a current collector, and an anode metal layer that extends along one or more faces of the current collector. The anode metal layer comprises at least a battery active metal composition, typically at least or essentially lithium metal. Optionally the active metal composition can comprise other battery active metals, such as (earth) alkali metals such as: K, Na, and Ca. The anode metal layer comprises at least one graded metal alloy layer. The graded metal alloy extends, preferably essentially conformably, along one or more opposing faces of the anode metal layer.

Depending on the position of the graded metal alloy layer the layer may be understood as a cover layer provided along a face of the anode metal layer opposite the current collector or as an interlayer that extends in between the anode metal layer and the current collector.

The graded metal alloy layer comprises a mixture of the battery active metal composition, typically lithium metal, and a further metal composition other than the active metal composition. The further metal composition can comprise one or more other metals (typically other than lithium) that alloy with the battery active metal composition. The metals are typically selected to at least have a lower redox potential than the battery's active anode active composition. The abundance (e.g. concentration in vol %) of lithium (battery active metal(s)) relative to the further metal composition decreases in a direction away from an interface with the anode metal layer. In a direction orthogonal thereto (along the interface with the anode metal layer) the relative abundance is metals in the mixture is preferably constant.

The concentration of lithium (anode active metal) relative to the further metal composition decreases gradually from a maximum (e.g. 100%) at an interface with the anode metal layer to a minimum (e.g. 0%) at an interface across the thickness of the graded metal alloy layer.

Alternatively, or in addition, the concentration of lithium decreases step-wise from a face at the anode layer. Accordingly, in some preferred embodiments, the graded metal alloy layer can be provided as a multilayer stack comprising a plurality of sublayers, whereby the concentration of lithium metal (anode metal) relative to the further metal composition in subsequent sublayers of the stack decreases in a direction away from the anode metal layer. As such the graded metal alloy layer and/or the anode metal layer may be understood as forming a laminate, e.g. a nanolaminate.

Without wishing to be bound by theory inventors find that advantages of providing the graded layer comprising the mixture of the battery active metal composition, typically lithium, and a further metal composition other than the active metal composition, relate to formation of a layer having anisotropic volumetric expansion. This is believed to suppress volume and surface changes upon repeated insertion and extraction of anode metals (e.g. Li) upon battery cycling, especially in the first and/or first number of cycles, thus preventing gradual degradation of the metal anode layer.

Depending on a position below and/or above the anode metal layer the graded metal alloy layer can provide a function of a passivation layer and/or a seed layer.

Providing the metal alloy layer with graded composition across a thickness, was found to advantageously reduce an overall amount of material (the further metal composition) that does not partake in battery reaction, without affection the beneficial properties as described herein.

As will be elaborated in more detail herein below the graded metal alloy layer, can, as a seed layer, advantageously mitigate inhomogeneous anode metal plating (in particular during an initial charging cycle and/or during subsequent charging operations during battery operation). Additionally, the seed layer can enable homogeneous anode metal stripping during battery discharge operations. In combination these effects advantageously contribute to increasing battery performance, durability, and/or safety, by mitigating formation of isolated anode metal domains (so-called mossy domain structure) and/or by mitigating formation or propagation of so-called dendrites.

When provided as passivation layer, the graded metal alloy layer can advantageously mitigate degradation of the anode metal, such as adverse reactions due to exposure to ambient (O₂, CO₂, and/or N₂), which, in particular during battery assembly and/or electrode storage, result in loss of battery active material.

Accordingly, in some preferred embodiments the graded metal alloy layer is provided between the current collector and the anode metal layer, i.e. as an interface layer between the current collector and the anode metal layer, whereby the relative concentration of lithium in the mixture increases in a direction away from the current collector, preferably to 100% at an interface with the anode metal layer.

Accordingly, in some other or further preferred embodiments the graded metal alloy layer is provided along a face of the anode metal layer opposite the current collector, i.e. along an external face of the electrode opposite the current collector for interfacing with a separator of a battery system, wherein the relative concentration of lithium in the mixture decreases in a direction away from the anode metal layer, preferably to essentially 0 vol %. The higher the relative amount of the further anode metal towards the external interface the better protection of the underlying anode metal (e.g. Li) for adverse reactions with ambient.

In yet further preferred embodiments the electrode comprises one of the graded metal alloy layers along both faces of the anode metal layer, i.e. one graded metal alloy layer along the interface between the current collector and the anode metal layer and a further graded metal alloy layer along an external face of the electrode opposite the current collector. The composition of the further metal composition in each of these graded layers may be the same, but need not be the same. For example, the further metal composition comprised in the bottom (seed) layer may be selected to optimize electrical contact with the current collector and to provide optimal wetting of subsequent anode metal layers, whereas the further metal composition comprised in the top (passivation) layer may be selected for minimized reactivity towards ambient while being transgressive to anode metal or anode metal ions (e.g. Li metal/ions).

According to another or further aspect there is provided a secondary battery that comprises the electrode as disclosed herein. The battery further comprises separator and a counter electrode. The separator typically comprises and electrolyte composition, e.g. a solid, semi-solid or liquid electrolyte composition. The battery may further comprise one or more of an anolyte composition and/or a catholyte composition. The anode metal layer comprised in the electrode is provided with at least one graded metal alloy layer (above, below, or on both sides). The graded metal alloy layer, depending on the position, advantageously provides the battery with the benefits described as regard to passivation, seeding or both passivation and seeding.

In some embodiments, the battery is configured as a secondary anode metal battery, typically a secondary lithium metal battery (LMB), wherein the counter electrode comprises a layer of a cathode composition that is loaded with anode metal cations (lithium ions for a LMB). In a preferred embodiment, the anode metal layer has a thickness in a range of <20 μm prior to an initial charging cycle of the battery. The amount of anode metal (lithium for LMBs) thus provided was found to provide an effective buffer for replacing potential losses of an overall active anode metal inventory as provided by the cathode composition upon progressive battery cycling.

In other embodiments the overall active anode metal inventory can be determined by an initial amount of anode metal comprised in the anode metal layer (i.e. prior to initial battery cycling). For example, in one embodiment the battery is configured as a secondary lithium air battery. In another embodiment the electrode is used in assembly of a secondary lithium sulfur battery (Li-S).

In either case the amount of anode metal is preferably such that the areal capacity of the battery in mAh/cm² is ≥1, preferably ≥4. In terms of thickness, the anode metal layer preferably has a thickness ≥5 μm, more preferably ≥20 μm or more, e.g. up to 50 μm or 100 μm. When the anode metal layer (e.g. Li) is distributed over a 3D structured anode, the thickness can be adjusted appropriately.

According to yet another of further aspect there is provided a method of manufacturing an electrode as described herein. The method comprises: providing a current collector; depositing an anode metal composition comprising lithium as layer, and one or more steps of depositing a graded metal alloy layer comprising a mixture of lithium and a further metal composition, wherein the concentration of lithium relative to the further metal composition decreases outwardly from the anode metal layer. Deposition of the graded metal alloy layer generally comprises co-depositing lithium (or another anode metal composition) and the further metal composition.

In a preferred embodiment, co-depositing comprises one or more of vapor deposition and electrochemical deposition.

In another or further preferred embodiment, the method comprises repeatedly performing the step of depositing the graded metal alloy layer comprising a mixture of lithium and a further metal composition depositing, to form the graded metal alloy layer as a multilayer stack comprising a plurality of subsequently deposited sub-layers, whereby the concentration of lithium in subsequent sublayers of the stack decreases in a direction from a first sublayer at the anode metal layer.

In other or further preferred embodiments, preferably whereby the current collector is a flexible elongate foil, e.g. a metal or metal-coated foil, the method can advantageously be configured as a roll-to-roll process that comprises passing the current collector past respective spatially separated stations, e.g. stations in adequately conditioned inert atmosphere (e.g. practically free of humidity, oxygen, CO₂ and/or N₂), for performing the steps of depositing of the anode metal composition and deposition of the graded metal alloy layer, including the sublayers if any.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A provides a cross-section side view of an anode metal layer and a graded metal alloy layer;

FIGS. 1B and 1C provide cross-section side views of embodiments of an electrode comprising a current collector, an anode metal layer and a graded metal alloy layer;

FIG. 2A provides a cross-section side view of an electrode comprising a graded metal alloy layer anode along opposing faces of an anode metal layer; and

FIG. 2B provides a cross-section side view of an electrode comprising a graded metal alloy layer provided as multi-layer stack;

FIG. 2C illustrates step-wise (left) and gradual (right) Li-metal concentration profiles;

FIGS. 3A and 3B provide cross-section side views of electrodes;

FIG. 3C provides an exploded cross-section side-view of a secondary lithium metal battery; and

FIGS. 4A to 4D provide schematic views of methods of manufacturing an electrode.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

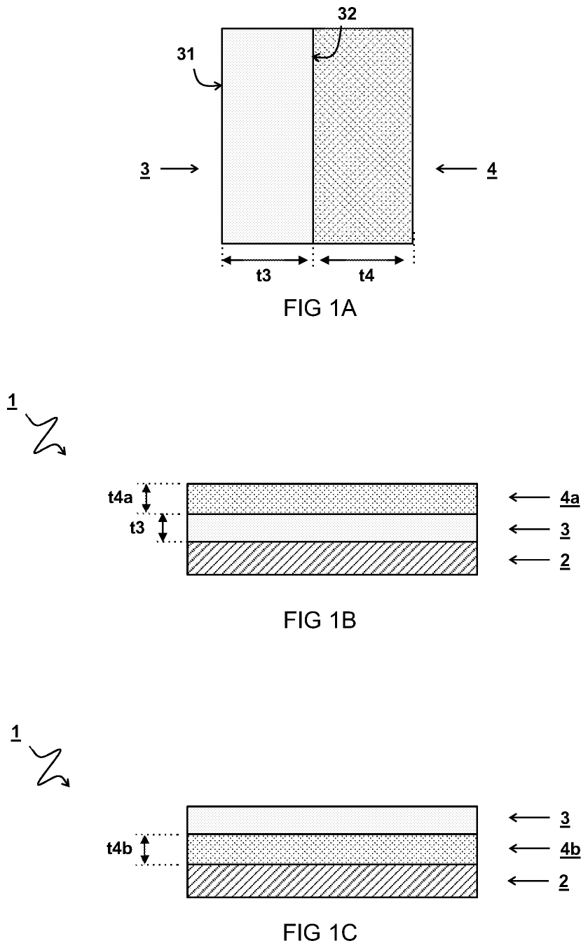

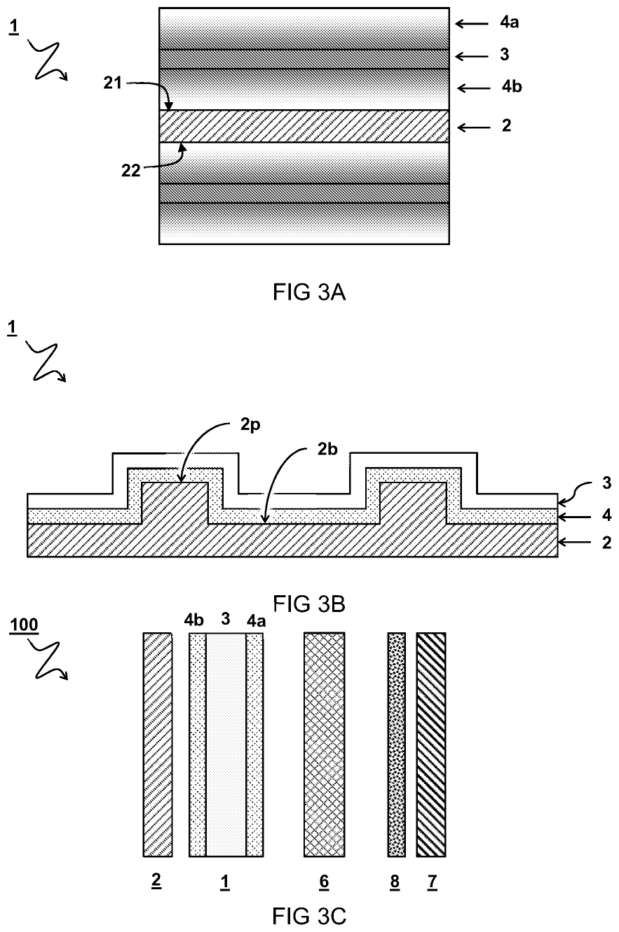

The electrode 1 will now be explained in further detail with reference for FIGS. 1 to 3B. As will be explained with further reference to FIG. 3C the electrode can be of particular benefit in the assembly of a secondary anode metal battery.

The electrode 1, e.g. as shown in FIGS. 1B, 1C, 2A, 2B, 3A and 3B comprises a current collector 2; an anode metal layer 3; and at least one graded metal alloy layer 4,4a,4b. The anode metal layer 3 comprises, or essentially consists of, one or more element selected from Na, K, Mg, and/or Ca, preferably Li. The graded metal alloy layer comprises a mixture of the one or more element comprised in the anode metal layer 3 (preferably lithium) and a further metal composition comprising one or more other elements as described above that alloy with the anode metal.

As illustrated in FIG. 1A the graded metal alloy layer 4 extends as a conformal layer along one or more opposing faces 31,32 of the anode metal layer 3.

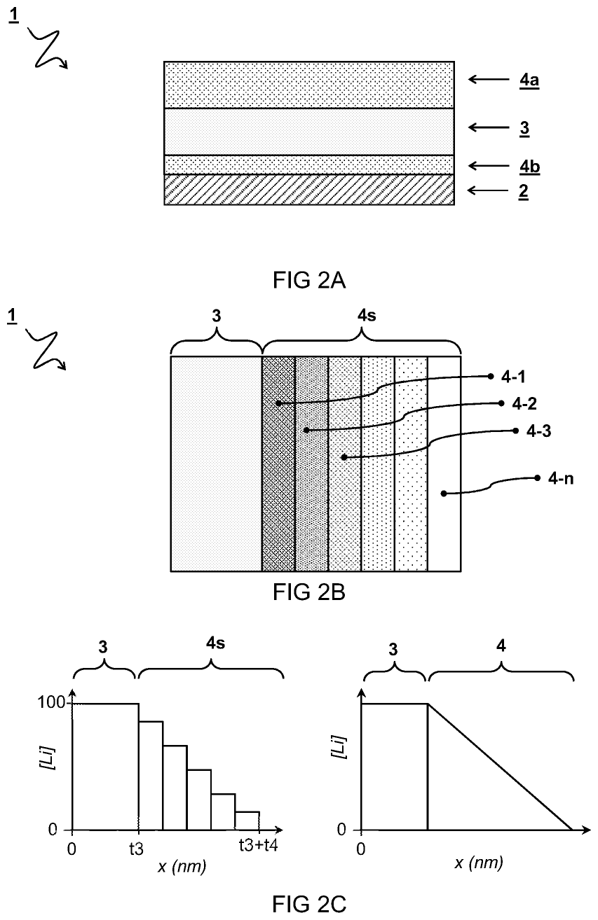

As will be elaborated in further detail with reference to FIG. 2C, the concentration in vol %, or relative abundance of the anode active (e.g. Li) relative to the further metal composition decreases outwardly from an interface between the anode metal layer 3 and the graded metal alloy layer 4.

The thickness of the anode metal layer t3 and the thickness of the graded metal alloy layer t4, t4a, t4b, as well as the position of the anode metal layer 3 and the graded metal alloy layer 4 relative to the current collector 2 generally depend on the intended application of the electrode, e.g. the type of battery system the electrode is to be used in.

In one embodiment, e.g. as shown in FIG. 1B, the anode metal layer 3 is provided as in interlayer that extends between the current collector 2 and the graded metal alloy layer 4a. As such the graded metal alloy layer 4a can be understood as forming a cover layer that faces ambient prior to assembly into a battery. As such the graded metal alloy layer 4a forms a protective layer, a passivation layer, that mitigates adverse reaction (degradation) of the underlying anode metal layer 3, e.g. by exposure to ambient prior and/or during assembly into a battery system.

In another or further embodiment, e.g. as shown in FIG. 1C, the graded metal alloy layer 4b, is provided as an interlayer between the current collector 2 and the anode metal layer 3. As such the graded metal alloy layer 4b can be understood as forming seeding layer for receiving a layer of anode metal composition, e.g. by deposition prior to assembly into a battery system and/or by a plating or charging route as part of an assembled battery system (e.g. as shown in FIG. 3C).

In yet further embodiments, e.g. as illustrated in FIGS. 2A, 3A and 3C, the electrode 1 comprises a first and a second graded metal alloy layer 4a,4b, whereby one layer forms a seed layer 4b that is provided as an interlayer between the current collector 2 and the anode metal layer 3 and whereby the other layer forms a passivation layer that is provided along a face of the anode metal layer 3 opposite the seed layer.

The further metal composition comprises one or more elements selected from: zinc, magnesium, and/or group 13-15 metal or metalloid elements, preferably one or more of Zn, Mg, Al, Ga, In, Sn, C, Ge, Si, and/or Bi. An important aspect for the effect of suppressing volumetric changes (reduced gradation during battery cycling) is that the resulting alloy has a comparatively reduced volume expansion, whereby lower volumetric expansions are increasingly preferred. Accordingly, the further metal composition preferably comprises one or more of indium (In), zinc (Zn), magnesium (Mg), bismuth (Bi) and/or tin (Sn), most preferably tin.

Ternary alloys (e.g. Li-Cu-Sn), quaternary alloys (e.g. Li-Al-O-N), or higher are possible. Reference in this regard is made to compositions disclosed in a publication by Y. Zhu, et al., in Adv. Sci. 1600517 (2017), which is hereby incorporated by reference).

Preferably, the current collector comprises, or essentially consists of, a metal foil or a metal-coated polymer foil, preferably comprising copper (Cu), nickel (Ni), or a composite comprising one or more thereof.

In some embodiments, the current collector may be a so-called 3D current collector or a composite 3D current collector that comprises a plurality of high aspect ratio conductive scaffolding elements that are oriented away (e.g. about normal) from the foil. For example, the conductive scaffolding elements can comprise vertically aligned carbon nanotubes, e.g. a pillar array grown from a catalyst seed on the Cu foil. Accordingly, in some embodiments, the electrode comprises a structured current corrector that compromises a plurality of electrically conductive protrusions that are extending from a base and that are covered by the anode metal layer and the graded metal alloy layer.

In some embodiments, the graded metal alloy layer has a thickness t4, t4a, t4b in a range of 5-500 nm. For a seed layer the thickness t4b is preferably in a range of 5-25 nm. Seed layers having a thickness within this range were found to provide efficient mitigation of volumetric expansion and seeding while minimizing a content of inactive metal.

When the graded metal alloy layer is provided along a face of the anode metal layer for interfacing with a separator of the battery (as a passivating or protective layer) a thickness t4a of about 50-100 nm was found to provide efficient mitigation of volumetric expansion during cycling and shielding from ambient with minimal content of inactive metal.

The thickness of the anode metal layer t3 equally depends on an intended application. In principle the thickness can range from infinitesimal thin to thicknesses up to the order of 20 μm or more. Note that in some embodiments, the anode metal layer may be part of, or overlap, with a portion, e.g. an outermost sublayer, of the graded metal alloy layer.

In other or further embodiments the anode metal layer may be identified as a layer having thickness, typically ≤20 μm, in accordance which a predefined amount of anode metal. The amount of anode metal provided can be understood as a buffer amount to, during battery operation, replace anode metal losses from an overall anode metal inventory, e.g. as defined by the cathode composition. In yet other or further embodiments, such as in electrodes configured for assembly within an anode metal-air battery (e.g. a Li-air battery) or an anode metal-sulfur battery (e.g. Li-S) the anode metal layer may be identified as a layer having a thickness, typically ≥5 μm, in accordance with an overall anode metal (e.g. Li) inventory of the system.

In some embodiments, e.g. as illustrated in FIG. 2C (right) the concentration of lithium (anode active metal) relative to the further metal composition decreases gradually from a maximum (e.g. 100%) at an interface with the anode metal layer to a minimum (e.g. 0%) at an interface across the thickness of the graded metal alloy layer.

Of course the concentration of anode active metal relative to the further metal composition need not necessarily span a range from about one hundred percent at the anode metal layer 3 to about zero percent at an opposing interface across the graded metal alloy layer 4. Other ranges are also envisioned, e.g. ranges having an upper limit of about 90, 80 or 70%, and/or ranges having a lower limit of about 10, 20 or 30%, such as 100-10%, 100-20%, 100-30%, 90-0%, 90-10%, 90-20%, 90-30%, 80-0%, 80-10%, 80-20%, 80-30%, 70-0%, 70-10%, 70-20%, or 70-30%.

However, for passivation layers it is strongly preferred that the concentration of the anode active metal (e.g. Li) decreases to about zero percent to mitigate adverse reactions, for example lithium with ambient.

In some preferred embodiments, e.g. as shown in FIGS. 2B and 2C (left), the graded metal alloy layer 4 is provided as a multilayer stack 4s comprising with a plurality of sublayers 4-1,4-2,4-3,4-n, whereby the concentration of lithium relative to the further metal composition in subsequent sublayers 4-2,4-3,4-n of the stack decreases from a first sublayer 4-1 at the anode metal layer 3.

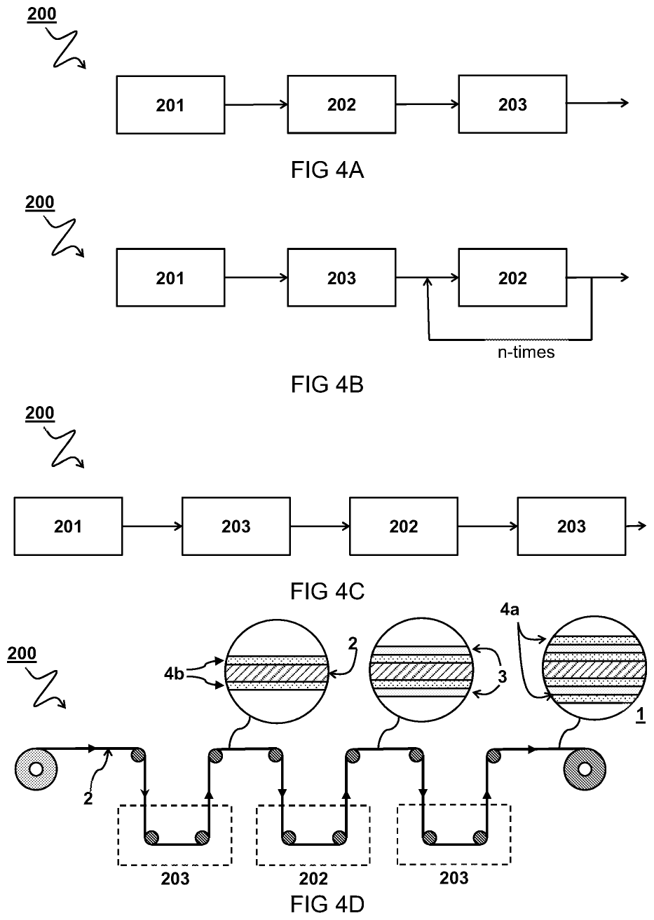

Providing the graded metal alloy layer and/or the anode metal layer as a laminate was found to offer advantages in terms of uniformity across a production batch and in terms of reducing of production complexity. As will be explained in further detail with reference to FIG. 4D, a (nano) laminate can be particularly effectively provided by continuous manufacturing processes, such as a roll-to-roll (R2R) process, whereby subsequent sublayers are provided at spatially separated and preferably air-excluded processing units (e.g. R2R production line comprising multiple deposition units that can be individual configured to deposit a specific mixture for a given sublayer).

Alternatively or in addition, continuous or at least semi-continuous gradients, e.g. as illustrated in FIG. 2C (left), may be provided by one or more processing units, e.g. deposition stations, configured for temporal regulation of deposition parameters.

Advantageously, the electrode can be implemented as a dual-sided electrode. For example, by providing the anode metal layer and the at least one graded metal alloy layer as disclosed herein along two opposing faces (front and back face) of a common current collector. Alternatively, a dual-sided electrode may be provided by back-to-back positioning of two single-sided electrodes. Dual-sided electrodes can advantageously be used in manufacturing and assembly, of batteries with improved energy density by providing an integrated electrode stack.

FIG. 3A illustrates an embodiment of as a dual-sided electrode 1 comprising a first one of the anode metal layer and the at least one graded metal alloy layer as disclosed herein along a first face 21 of a single electrode foil 2 and a second one of the anode metal layer and the at least one graded metal alloy layer as disclosed herein along a second face 22 of a single electrode foil 2. In some embodiments, e.g. as shown the dual-sided electrode comprises two graded metal alloy layers 4a,4b on each side of the current collector 2, i.e. one graded layer 4b between the anode metal layer 3 and the current collector 2 and a further grade layer 4b along a face of the anode metal layer 3 opposite the current collector 2. The color gradient in layers 4a and 4b indicates that the concentration of anode metal (preferably Li) decreases outwardly from the anode metal layer 3.

Of course the dual-sided electrode may be implemented differently, e.g. in line with one or more of the arrangements discussed in relation to FIGS. 1B, 1C and 2A. Similarly it will be understood that the graded metal alloy layers of the dual-sided electrode may be implemented in accordance with one or more of the continuous and/or step-wise gradient described in relation to FIG. 2C.

FIG. 3B provides a cross-section side view of an electrode 1, wherein the current collector 2 is a 3D-structured current corrector that compromises a plurality of electrically conductive protrusions 2p. The protrusions extend from a base 2b, e.g. a top face of the foil, and are covered by the anode metal layer 3 and the graded metal alloy layer 4.

The height and separation of the protrusions is generally limited by an ability to provide conformal coverage of the graded metal alloy layer, respectively the anode metal layer. Typically the aspect ratio (AR) of the interspace between the pillars (height/width) is generally ≤50. When physical vapor deposition PVD is used to deposit the respective layers conformal coverage was realized for AR≤5. When electrodeposition is used the upper limit may be higher, e.g. ≤50. For sputter deposition and e-gun evaporation the aspect ratio is typically ≤5. With so-called ionized sputtering conformal coverage can be obtained for AR≤10.

FIG. 3C provides an exploded cross-section side-view of a secondary lithium metal battery 100 comprising the electrode 1 as disclosed herein. The secondary lithium metal battery 100 further comprises at least a separator 6 and a counter electrode 7. As known the separator will provided for anode metal ion transport between the opposing electrodes during battery operation. For this reason the separator typically comprises a salt composition comprising ions of the anode metal (e.g. Li⁺). In addition the battery can comprise one more additives such as an anolyte and/or a catholyte to mitigate interfacial resistance at, respectively, the anode and cathode side of the separator.

In a preferred embodiment, e.g. as shown in FIG. 3C, the battery's the counter electrode 7 comprises a layer of a cathode composition 8. The cathode composition comprises anode metal ions, e.g. lithium ions. The anode metal ions can be used (e.g. in an initial charging cycle) to plate anode metal (e.g. Li metal) onto the anode, e.g. onto one or more of the seed layers (graded metal alloy layer 4b), and the anode metal layer 3. When the anode metal is lithium such batteries are generally referred to as secondary lithium metal batteries (LMB). The amount of anode metal comprised in the cathode can essentially define an overall anode metal inventory (capacity) of the secondary battery 100. As discussed above, the amount of metal comprised into anode metal prior to initial charging can advantageously provide a buffer amount to replace anode metal losses during prolonged battery cycling. For embodiments comprising a cathode composition that essentially define an overall anode metal inventory (capacity) of the secondary battery the thickness of the anode metal layer (prior to initial charging) is preferably <20 μm.

In another embodiment, wherein the battery is configured as a lithium-air (Li-air) or lithium sulfur (Li-S) battery. It will be understood that for Li-Air and Li-S batteries a cathode composition that comprises anode metal ions is not required. Instead, the redox reaction of lithium metal is balanced against, respectively, air and a sulfur containing composition. As thus the overall active anode metal inventory can be defined by the anode metal layer that is provided to the electrode 1 prior to initial operation of the battery. To allow for a commercially relevant capacity, the thickness of the anode metal layer 3 is typically ≥5 μm, preferably more, e.g. ≥20 μm or more, e.g. up to 50 μm or 100 μm.

In general, the method 200 of manufacturing an electrode 1 for a secondary lithium metal battery 100, comprises at least the steps of: providing 201 a current collector; depositing 202 an anode metal composition comprising lithium as layer, and one or more steps of depositing 203 a graded metal alloy layer comprising a mixture of lithium and a further metal composition, wherein the concentration of lithium relative to the further metal composition decreases outwardly from the anode metal layer. The order of steps 202 and 203 can vary depending on the position of the graded metal alloy layer 4 relative to the anode metal layer 3 (i.e. above, below, or both). In some embodiments the graded metal alloy layer is deposited on top of (after) the anode metal layer, e.g. as shown in FIG. 4B. In other embodiments one or more graded metal alloy layers are deposited prior to deposition of the anode metal layer, e.g. as shown in FIG. 4A. Optionally, part of or the entire anode metal layer 3 can be provided after assembly of the electrode in a battery system, e.g. as described in relation to FIG. 3C. In some embodiments, e.g. as shown in FIG. 4C and 4D, a graded metal alloy layer 4 is deposited prior to and after deposition of the anode metal layer 3.

Depositing 203 the graded metal alloy layer comprises co-depositing lithium and the further metal composition. Co-deposition, i.e. deposition of both an anode metal composition and one or more further metals, was found to be a suitable method to provide layers having a graded composition as disclosed herein, e.g. a gradual and/or layer-wise concentration gradient. Co-deposition can include one or more of vapor deposition and electrodeposition of the respective compositions (e.g. lithium and the further metal composition) from one or more suitable processes. Suitable processes include chemical and physical vapor deposition and electroplating. The gradual and/or a stepwise gradient can be obtained by providing appropriate temporal variations (over a deposition period), e.g. changing the concentration or deposition conditions. Alternatively, or in addition, gradients can be obtained by processing the electrode at a plurality of spatially or temperature-separated stations, each set to provide a layer of a particular thickness at a given concentration.

Accordingly, in some embodiments, e.g. as indicated in FIG. 4B, the method comprises repeatedly performing the step of depositing the graded metal alloy (e.g. n times) layer to form the graded metal alloy layer as a multilayer stack comprising a plurality of subsequently deposited sub-layers (n layers), whereby the concentration of lithium in subsequent sublayers of the stack decreases in a direction from a first sublayer at the anode metal layer (see layers 4-1, 4-2, 4-n in FIG. 2B).

Advantageously the electrode, and method, as disclosed herein are particular suited for large-scale production, e.g. by continuous production methods such as roll-to-roll (R2R) processing.

FIG. 4D illustrates an implementation of a R2R production method configured to provide a double-sided electrode 1, whereby the anode layer is sandwiched between corresponding graded metal alloy layers 4a,4b, along both faces of the current collector 2. Accordingly, in some embodiments, the current collector is an elongate metal foil or metal-coated polymer foil and wherein the steps of depositing of the anode metal composition and the graded metal alloy layer, including the sublayers if any, are configured as a roll-to-roll process.

For the purpose of clarity and a concise description, features are described herein as part of the same or separate embodiments, however, it will be appreciated that the scope of the invention may include embodiments having combinations of all or some of the features described. Of course, it is to be appreciated that any one of the above embodiments or processes may be combined with one or more other embodiments or processes to provide even further improvements in finding and matching designs and advantages.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An electrode (1) for a secondary lithium metal battery (100), the electrode comprising
a current collector (2),
an anode metal layer (3) comprising lithium, and
at least one graded metal alloy layer (4) extending along one or more opposing faces of the anode metal layer, the graded metal alloy layer comprising a mixture of lithium and a further metal composition other than Li, wherein the concentration of lithium relative to the further metal composition decreases outwardly from the anode metal layer.

2. The electrode according to claim 1, wherein the concentration of lithium relative to the further metal composition decreases outwardly from the anode metal layer across the graded metal alloy layer (4).

3. The electrode according to claim 1, wherein the anode metal layer (3) overlaps with a portion of the graded metal alloy layer (4).

4. The electrode according to claim 1, wherein the graded metal alloy layer (4) is a multilayer stack (4s) with a plurality of sublayers (4-1,4-2,4-n), whereby the concentration of lithium relative to the further metal composition in subsequent sublayers (4-2,4-n) of the stack decreases from a first sublayer (4-1) at the anode metal layer (3).

5. The electrode according to claim 1, wherein the graded metal alloy layer (4) is provided between the current collector (2) and the anode metal layer (3), and wherein the relative concentration of lithium in the mixture increases in a direction away from the current collector.

6. The electrode according to claim 4, 4, wherein the graded metal alloy layer (4) is provided along a face of the anode metal layer (3) opposite the current collector, for interfacing with a separator (6), and wherein the relative concentration of lithium in the mixture decreases in a direction away from the anode metal layer.

7. The electrode according to claim 1, wherein the electrode comprises two of the graded metal alloy layers (4), wherein: one of the graded metal alloy layers (4) is provided between the current collector (2) and the anode metal layer (3), and the relative concentration of lithium in the mixture increases in a direction away from the current collector, and the other one of the graded metal alloy layers (4) is provided along a face of the anode metal layer (3) opposite the current collector, for interfacing with a separator (6), and wherein the relative concentration of lithium in the mixture decreases in a direction away from the anode metal layer.

8. The electrode according to claim 1, wherein the concentration of lithium in the graded metal alloy layer (4) decreases from essentially 100% relative to the further metal composition at the anode metal layer to essentially 0% across the graded metal alloy layer (4).

9. The electrode according to claim 1, wherein the further metal composition comprises one or more of indium (In), zinc (Zn), magnesium (Mg), bismuth (Bi) and/or tin (Sn).

10. The electrode according to claim 1, wherein the current collector (2) is comprised of a metal foil or a metal-coated polymer foil.

11. The electrode according to claim 1, wherein the graded metal alloy layer (4) has a thickness (t4) in a range of 5-500 nm.

12. The electrode according to claim 1, wherein the current collector (2) is a structured current corrector that compromises a plurality of electrically conductive protrusions (2p) extending from a base (2b) that are covered by the anode metal layer (3) and the graded metal alloy layer (4).

13. The electrode according to claim 1, comprising respective ones of the anode metal layer (3) and the at least one graded metal alloy layer (4) on opposing sides of a common current collector (2).

14. A secondary battery (100) comprising the electrode (1) according to claim 1 as an anode, a separator (6) and a counter electrode (7).

15. The secondary battery system according to claim 14, comprising a layer of a cathode composition (8) loaded with lithium ions, and wherein the anode metal layer (3) has a thickness (t3) in a range of <20 μm.

16. The secondary battery according to claim 14, wherein the secondary battery is configured as a lithium-air or lithium sulfur battery and whereby the anode metal layer has a thickness (t3)≥5 μm.

17. A method (200) of manufacturing an electrode (1) for a secondary lithium metal battery (100), the method comprising:
providing (201) a current collector,
depositing (202) an anode metal composition comprising lithium as layer, and
one or more steps of depositing (203) a graded metal alloy layer comprising a mixture of lithium and a further metal composition, wherein the concentration of lithium relative to the further metal composition decreases outwardly from the anode metal layer,
wherein depositing (203) the graded metal alloy layer comprises co-depositing lithium and the further metal composition.

18. The method according to claim 17, wherein the co-depositing lithium and the further metal composition comprises one or more of vapor deposition and electrodeposition.

19. The method according to claim 17, comprising repeatedly performing the step of depositing the graded metal alloy layer to form the graded metal alloy layer as a multilayer stack comprising a plurality of subsequently deposited sub-layers, whereby the concentration of lithium in subsequent sublayers of the stack decreases in a direction from a first sublayer at the anode metal layer.

20. The method according to claim 17, wherein the current collector is an elongate metal foil or metal-coated polymer foil and wherein the steps of depositing of the anode metal composition and the graded metal alloy layer, including the sublayers if any, are configured as a roll-to-roll process.
